(19) United States
(12) Patent Application Publication
(10) Pub. No.: US 2013/0118318 A1
(43) Pub. Date: May 16, 2013

(54) Open-End Ratchet Wrench

(71) Applicant: DeBoya Robertson, Dallas, TX (US)

(72) Inventor: DeBoya Robertson, Dallas, TX (US)

(21) Appl. No.: 13/294,074

(22) Filed: Nov. 10, 2011

(51) Int. Cl. B25B 13/46; B25B 13/08

(52) U.S. Cl. 81/92

(57) ABSTRACT

The open end ratchet wrench is comprised of high tolerance metal, which is made of two sections a said open end and said bar. The said open end ratchet wrench resembles a conventional wrench with the exception of a ratcheting mechanism in the open end. The first section of the open end has anti-slip jaws, also has a magnet inside of it, also a high tolerance said semi metal gear below the magnet. The open end has said tracks inside, below the gear. The second section of the open end ratchet is the bar, which has two high tolerance said rods at the top with high tolerance said roller on each end. The said bar also has inside of it a high tolerance metal gear arm at the top. There's a toggle switch that is pressed into the gear arm. Here's an innovative tool.

This application claims priority to provisional application No. 61/429,795 filed on Jan. 5, 2011.

### BACKGROUND OF THE INVENTION

Many times, a nut or bolt is located in a hard to reach area, such as behind an engine in a vehicle, or between the truss of an escalator and the axle that controls the handrail. Tightening or loosen the bolt or nut can be a time-consuming and a grueling process. In some instances, the nut or bolt cannot be removed utilizing conventional tools and other nearby parts, or areas may have to be reconfigured to accommodate an instrument. Nuts or bolts may also easily slip out of a traditional wrench and create further problems for an individual. A more efficient method and tool is needed.

### SUMMARY OF THE INVENTION

The Open-End Ratchet Wrench is designed to facilitate the loosening and tightening of inaccessible nuts and bolts. It enables individuals to access hard to reach areas on equipment, vehicles and machines without strain to the wrist and hand. This product can be used by anyone, but is especially ideal for use by mechanics working on automobile, buses, trains, airplanes, and more. This innovative item is designed to save user time, money and effort.

### DETAILED DESCRIPTION OF INVENTION

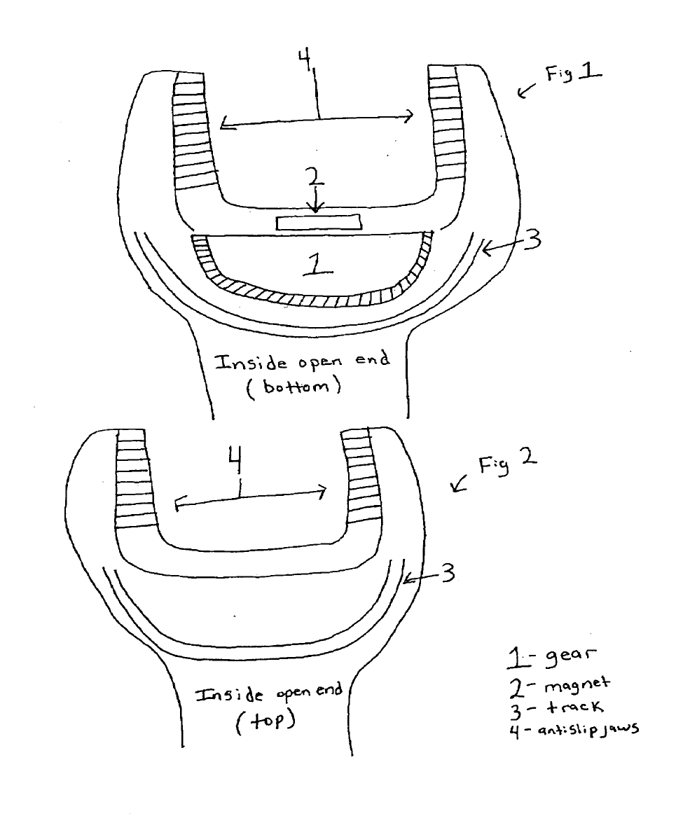

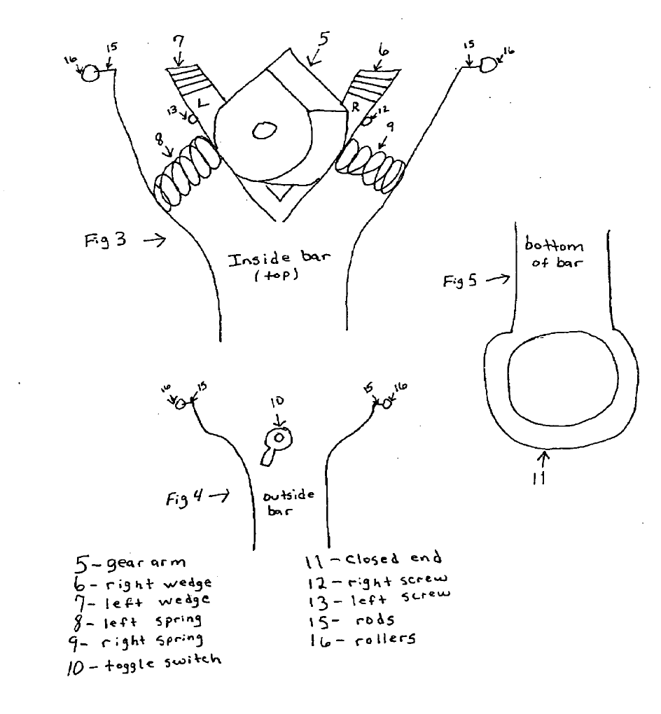

The Open-End Ratchet Wrench allows user to quickly and easily tighten and loosen nuts and bolts that may be located in hard to reach area. The invention is comprised of an open-ended ratchet wrench. The device resembles a conventional wrench with the exception of its being in two sections (open-end (FIG. 1,2), and bar (FIG. 3,4, 5)) connected together. A semi circular gear (1) is inside the open-end, with a low permability magnet (2) above the gear (1). The magnet (2) is positioned at the base of the open-end section, with two U shaped tracks (3) just below the gear (1) one on each side of the open-end (FIG. 1,2). The jaws (4) of the open-end (FIG. 1,2) has grooves therein creating a anti-slip affect against the nuts or bolt. The second section (FIG. 3,4,5) is the bar which has two metal rods (15) at the top on the right and left side, along with metal rollers (16) on each end of it, which goes inside the U shaped tracks (3) in the open-end (FIG. 1,2). The bar (FIG. 3) also has inside of it at the top just below the metal rods (15) a pivoting gear arm (5), with a wedge (6,7) on the left and right side of it holding it in position under the semi circular gear (1) in the open-end (FIG. 1). The wedges (6,7) has two screws (12,13) and two coil springs (8,9) holding it in position and giving it the retracting capability as the wrench is in working motion. Outside the bar (FIG. 4) has a fixed hole just above the gear arm (5), which has a fixed hole in the center of it for the toggle switch (10) which is pressed into the gear arm (5) controlling the direction of the open-end (FIG. 1,2). The bar also has at the bottom of it a closed end (11).

### DETAILED DESCRIPTION OF DRAWINGS

FIG. 1. is a perspective veiw of the bottom part of the open-end section of the invention, which has the semi circular gear (1) in the center, and the low permability magnet (2) above it, with a U shaped track (3) below the gear, with anti-slip jaws (4).

FIG. 2. is a perspective view of the top part of the open-end section of the invention, with a U shaped track (3) in the same position as the one in the bottom part, also showing the anti-slip jaws (4).

FIG. 3. is a perspective view of the second section of the invention, the inside of the bar, which have the gear arm (5) that give direction to the gear (1) in the open-end. It also shows the wedges (6,7) that holds the gear arm (5) in position, with a screw (12,13) and coil spring (8,9) on both sides of the wedges (6,7), giving it the retracting capability as the wrench is in working motion. It also have at the top of the bar the metal rods (15) and metal rollers (16) that goes inside the U shaped tracks (3) in the open-end.

FIG. 4. is a perspective view of the second section of the invention, the outside of the bar has a fixed hole near the top just above the gear arm (5), which also has a fixed hole in the center of it, which is for the toggle switch (10) that control the direction of the gear arm (5).

FIG. 5. is a perspective view of the second section of the invention, the bottom of the bar which is a closed end (11).

What is claimed and desired to be secured by the United States Patent and Trademark Office is:

1. An open ended ratchet wrench comprising:
a high tolerance metal that resembles a traditional open end wrench, but in two sections, an open end, and bar with the exception of a semi circular metal gear inside the said open end section, and the pivoting gear arm and components in the said bar section.

2. The wrench of claim 1, wherein:
the first section in the said open end, it has two parts, a top and bottom.

3. The wrench of claim 2, wherein:
the bottom part has a semi circular gear in the center of it, and a said low permability magnet above the gear which is positioned at the base of the open end, and a U shape track just below the gear.

4. The wrench of claim 2, wherein:
the top part has a U shaped track in the same place as the bottom part.

5. The wrench of claim 2, wherein:
the jaws of the open end section has said grooves therein, creating an anti slip affect upon the said nut or bolt.

6. The wrench of claim 1, wherein:
the second section is the said bar.

7. The wrench of claim 6, wherein:
the said bar at the top of it has said metal rods going through it on the left and right side, metal rollers on both ends of the metal rods, which goes inside the U shaped tracks in the open end section.

8. The wrench of claim 6, wherein:
the inside of the said bar at the top just below the metal rods is a said metal pivoting gear arm, with said two metal wedges with grooves at the top of them, one on both sides of the gear arm holding it in position under the semi circular gear in the said open end section.

9. The wrench of claim 8, wherein:
the inside of the said bar also have two screws one on each side of the wedges holding them in position along with one coil spring below both screws giving the wedge and gear arm a retracting capability, as the wrench is in working motion.

10. The wrench of claim 6, wherein:
the outside of the said bar has a fixed hole in the center, just above the center of the gear arm, which has a fixed hole in the center of it, which is for the toggle switch that control the working direction of the open end.

11. The wrench of claim 6, wherein:
the bottom of the said bar has a closed end.
